(19) United States
(12) Patent Application Publication
(10) Pub. No.: US 2004/0248610 A1
(43) Pub. Date: Dec. 9, 2004

(54) Multiple Contents Distribution System Over Wireless Local Area Network

(76) Inventor: Christina Kwok-Han Chan, Northridge, CA (US)

Correspondence Address: CHRISTINA KWOK-HAN CHAN, 19943 AHWANEE LANE, NORTHRIDGE, CA, 91326, US

(21) Appl. No.: 10/250,154

(22) Filed: Jun. 7, 2003

(51) Int. Cl. H04Q 7/20

(52) U.S. Cl. 455/550.1

(57) ABSTRACT

The present invention is to provide an effective means of wirelessly distributing electronic contents such as Internet data and multiple streams of real-time multimedia programming over a wireless local area network (WLAN). It provides a facility to effectively utilize all radio channels of wireless medium allowed in a given WLAN implementation and enables wireless clients to participate in the wireless contents distribution with a single radio.

### CROSS REFERENCE TO RELATED APPLICATIONS

U.S. Pat. No. 5,960,344, Sep. 28, 1999 by Ronald L. Mahany U.S. Pat. No. 6,259,898 B1, Jul. 10, 2001 by Daniel E. Lewis

### BACKGROUND OF INVENTION

The present invention generally relates to wireless distribution of electronic contents such as Internet data or multimedia programming streams over Wireless Local Area Network (WLAN).

WLAN divides wireless medium into multiple radio channels based on frequency or other criteria adopted in a specific implementation of a given WLAN system. In one case, access point establishes a wireless local area network, commonly known as Basic Service Set (BSS) over a single radio channel. In another case, an access point may have multiple radios to establish multiple BSSs with each BSS over a different radio channel. Wireless clients register with BSS to exchange data over BSS. Access points provide registered wireless clients with access to external network. IEEE 802.11 family of WLAN standards adopted Carrier Sense Multiple Access (CSMA) as a means for accessing wireless medium in which each transmitter listens to its radio channel in wireless medium to see if it is available for transmission.

Wireless Local Area Network (WLAN) such as the one defined by IEEE 802.11 family of specifications including 802.11, 802.11a, 802.11b, 802.11g has gained wide-spread market acceptance. Its usage for non-time critical data transfer over WLAN is a common practice nowadays. However its usage for bandwidth-intensive applications such as real-time multimedia streaming application has been limited due to the lack of art in effectively utilizing all radio channels that are allowed in a given WLAN standard.

Some prior WLANs deal with data transmission over a single BSS based on Quality of Service requirement but they do not address data transmission beyond the data capacity of a single radio channel.

U.S. Pat. No. 5,960,344 to Mahany describes an access point with two radios. In one mode of operation both radios operate on the same channel to provide radio channel redundancy. In another mode of operation two radios are provided to have one radio monitor transmission from the other radio. In the third mode of operation dual radios offer path continuity when Distribution System path is disconnected. The use of multiple radios in this art was not for increasing bandwidth capacity of the network.

U.S. Pat. No. 6,259,898 to Lewis describes an art for an access point, which provides for simultaneous communications with two or more mobile terminals on different channels. In this art, each mobile terminal is registered with all communication channels that access point operates, and goes into a sleep mode with respect to all communications channels except for one. This art places a burden on access point to keep all mobile terminals registered on all communications channels and provide sleep mode services to mobile terminals. The burden increases as the number of communication channels increases. In addition, the usage of beacon in this art is not consistent with the usage as defined by such standard specifications such as IEEE 802.11 family of specifications; thereby, causing interoperability issues with standard-based wireless terminals.

The present invention describes an efficient means of distributing electronic contents such as Internet data and multiple streams of real-time multimedia programming over wireless local area networks. It provides a facility to efficiently utilize multiple radio channels of wireless medium allowed in a given WLAN implementation and allows wireless clients to participate in the wireless contents distribution with a single radio.

As new generations of WLAN specifications and implementations are developed, the present invention should be readily adaptable to them by people familiar with the art in WLAN and multimedia communications.

### SUMMARY OF INVENTION

The present invention is to provide an effective means of wirelessly distributing electronic contents such as Internet data and multiple streams of real-time multimedia programming over a wireless communication network based on Wireless Local Area Network (WLAN). It provides a facility to effectively utilize all radio channels of wireless medium in a given WLAN implementation and allows wireless clients to participate in the contents distribution cost-effectively with a single radio.

The present invention describes Wireless Contents Distribution System (WCDS) comprising a base system and one or more wireless clients. The base system comprises one or more access points with each access point equipped with one or more radios, contents source, external network path, distribution processor, and backbone link. Access points, contents source, distribution processor, external network path, and distribution processor are connected over backbone link. The distribution processor coordinates activities within WCDS. An example of backbone link is Ethernet. The examples of contents source are multimedia server and multimedia storage. External network path may be Ethernet connected to Internet or wireless local area network. External contents source is accessible through this path. Although the contents source is provided here to show that a contents source can be tightly built into base system, some embodiment of the present invention may not include contents source as part of base system. In some embodiment of the present invention the base system may be viewed as a single large access point that has more elements than conventional access points.

In one aspect of the present invention the base system establishes wireless local area network, commonly known as Basic Service Set (BSS), as needed as it receives request for content delivery or bandwidth reservation. This request may originate from wireless clients, contents server, or external network. In other embodiment of the present invention base system establishes more BSSs in advance than needed in anticipation of needing them in the future.

In another aspect of the present invention, base system, when receiving request from wireless clients for content delivery or bandwidth reservation with Quality of Service requirement, selects a BSS to use and informs the requesting wireless client of the selected BSS so that the requesting wireless client may participate in the BSS through the re-registration policy adopted in a given embodiment of the present invention. The base system may select an existing BSS to accommodate request for content delivery or bandwidth reservation. The base system may dynamically establish BSS upon receiving the request and select it for use. The base system may dynamically adjust the number of BSSs it maintains in accordance with the expected communication needs. In some embodiment of the present invention it is expected that the placement of access points and wireless clients is such that all BSSs established by base system are reachable by all wireless clients. When it is anticipated that this expectation is not met, the re-registration process may employ a scheme to verify that the requesting wireless client can be served on the selected Basic Service Set so that base system can assign a new Basic Service Set to serve the requesting wireless client if needed.

WCDS may designate one or more Basic Service Sets for the purpose of registration and require wireless clients to initially register only with these Basic Service Sets according to the authorization process adopted by a given embodiment of the present invention. Under this scheme the effect of registration is limited to the designated Basic Service Sets.

When a wireless client makes request for content delivery or bandwidth reservation that cannot be met with a data capacity of a single BSS, base system selects multiple Basic Service Sets for serving the request.

### BRIEF DESCRIPTION OF DRAWINGS

FIG. 1 describes Wireless Contents Distribution System.

FIG. 2 describes base system.

FIG. 3 describes the usage of BSS as Management BSS.

FIG. 4 describes the usage of BSS as Content BSS.

FIG. 5 describes how base system manages Management BSS.

FIG. 6 describes how base system manages Content BSS.

FIG. 7 describes activities of wireless client.

FIG. 8 describes how two Content BSSs are combined to accommodate a delivery of a single content whose bandwidth requirement exceeds that of a single BSS.

### DETAILED DESCRIPTION

The present invention is described with references to the included figures.

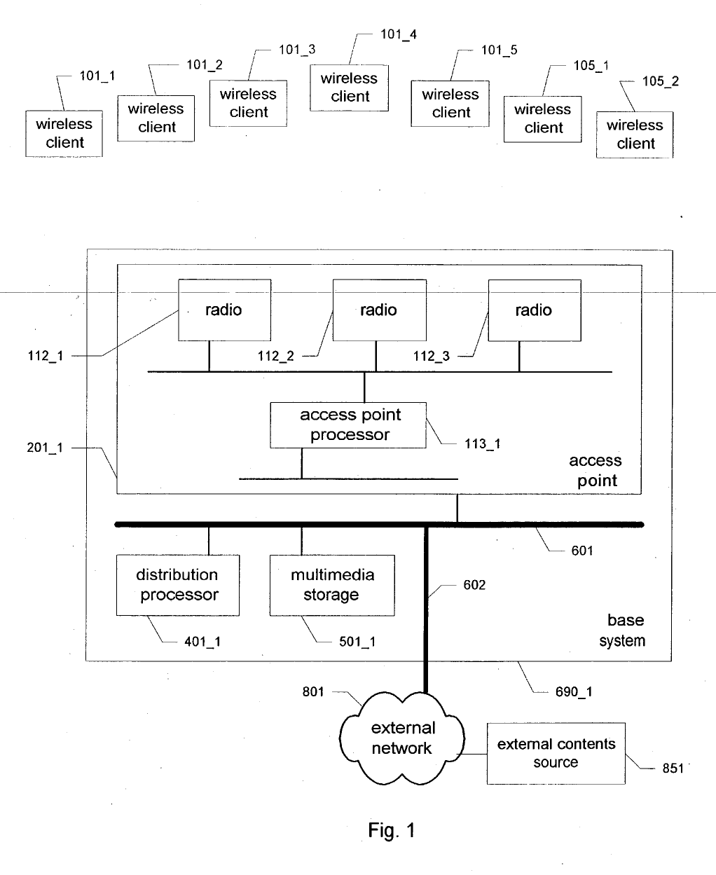

In FIG. 1, an exemplary embodiment of the present invention is provided. It is a wireless contents distribution system (WCDS) that distributes electronic contents such as Internet data and multiple streams of real-time multimedia programming over wireless local area networks referred to as Basic Service Sets (BSS) in the present invention.

WCDS comprises base system 690_1, wireless clients 101 and 105. Each wireless client 101 is equipped with one radio. Each wireless client 105 is equipped with two or more radios.

The base system 690_1 comprises one access point 201_1, multimedia storage 501_1, external network path 602, distribution processor 401_1, and backbone link 601.

The access point 201_1 has multiple radios 112, access point processor 113_1.

The access point processor 113_1 controls radios 112, communicates with distribution processor 401_1 to coordinate activities for contents distribution.

The multimedia storage 501_1 is the contents sources built into base system 690_1.

Access point 201_1, contents source 501_1, external network path 602, distribution processor 401_1 are connected over backbone link 601. An example of a backbone link is Ethernet.

The external network path 602 is a connection to external network 801 such as wired local area network or Internet. WCDS may receive multimedia contents from external network 801 through external network path 602 for distribution to wireless clients101 and 105.

The distribution processor 401_1 coordinates activities within WCDS. The distribution processor 401_1 handles contents delivery from service providers that are available through external network 801.

The number of BSSs that access point 201_1 can establish is limited by the number of radios it is equipped with.

Although multimedia storage 501_1 as a contents source is provided here to show that a contents source can be tightly built into base system 690_1, some embodiment of the present invention may not include contents source as part of WCDS; instead, base system 690_1 may access external contents source 851 for distribution to wireless clients 101 and 105.

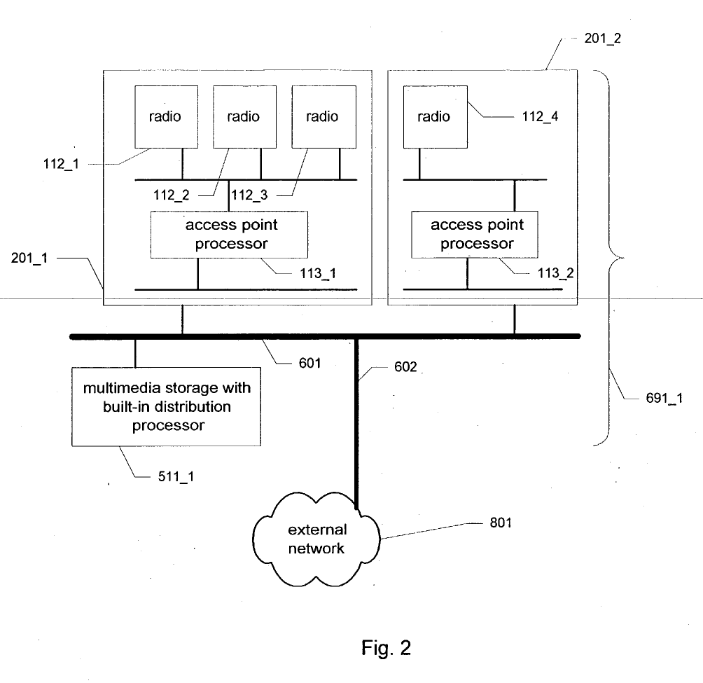

In FIG. 2, another exemplary embodiment of the present invention for a base system is provided to show how different combinations of components of base system are built into separate physical units. This base system 691_1 comprises access point 201_1 as a stand-alone unit, access point 201_2 as a stand-alone unit, multimedia storage with a built-in distribution processor 511_1 as a stand-alone unit, and a backbone link 601 through which access points 201 and multimedia storage with a built-in distribution processor 511_1 and external network path 602 are connected. An example of the backbone link 601 is Ethernet. In some embodiment of the present invention, AP processor may incorporate the role of distribution processor instead of having a separate distribution processor.

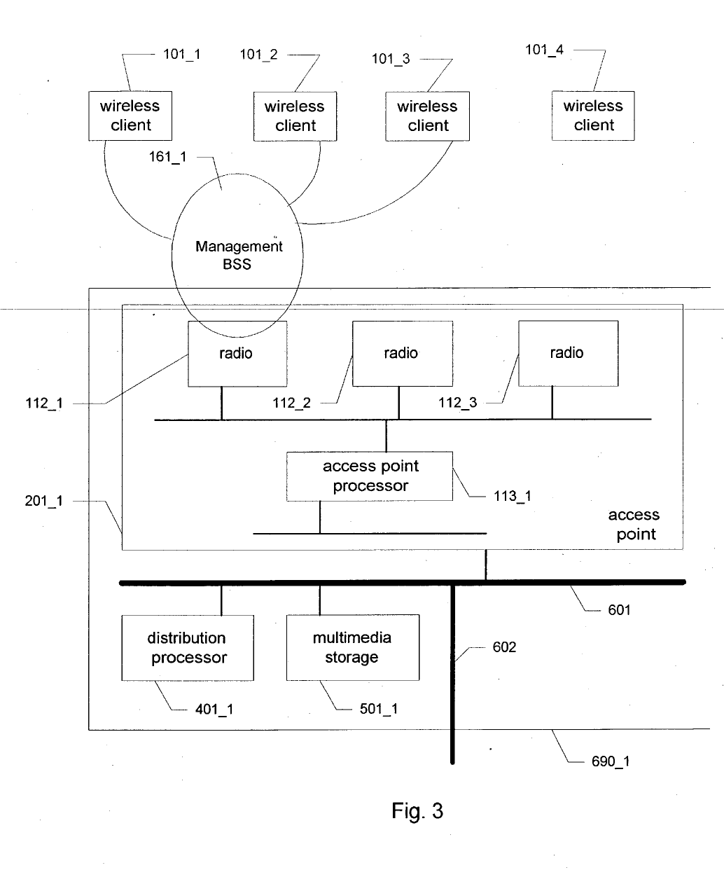

In FIG. 3, the usage of BSS as Management BSS in an exemplary embodiment of the present invention is described. BSS 161_1 is established by base system 690_1. Wireless clients 101_1, 101_2, and 101_3 are registered with BSS 161_1 according to the registration process adopted in a given embodiment of the present invention. Base system 690_1 provides services to registered wireless clients 101_1, 101_2, 101_3 over BSS 161_1 according to the Quality of Service scheme adopted for use on BSS 161_1 according to a given embodiment of the present invention.

The wireless client 101_4 requires no service from base system 690_1 and has not registered with BSS 161_1.

The base system may designate certain BSSs and allow initial registration of wireless clients only through these particular BS s, which are referred to as Management BSSs in the present invention. BSS 161_1 is designated as Management BSS in this example. The base system 690_1 provides access to the external network over external network path 602 for the registered wireless clients over Management BSS 161_1. The external network service accommodated over Management BSS 161_1 is limited by the data capacity of BSS 161_1. The base system 690_1 provides service to the registered wireless clients according to the Quality of Service policy adopted in a given embodiment of the present invention but the service provided over BSS 161_1 is limited by the data capacity of BSS 161_1. When base system 690_1 determines that additional Management BSS is required to serve additional wireless clients, it may establish more Management BSSs. When base system 690_1 determines that a certain Management BSS is no longer needed, it de-establishes Management BSS.

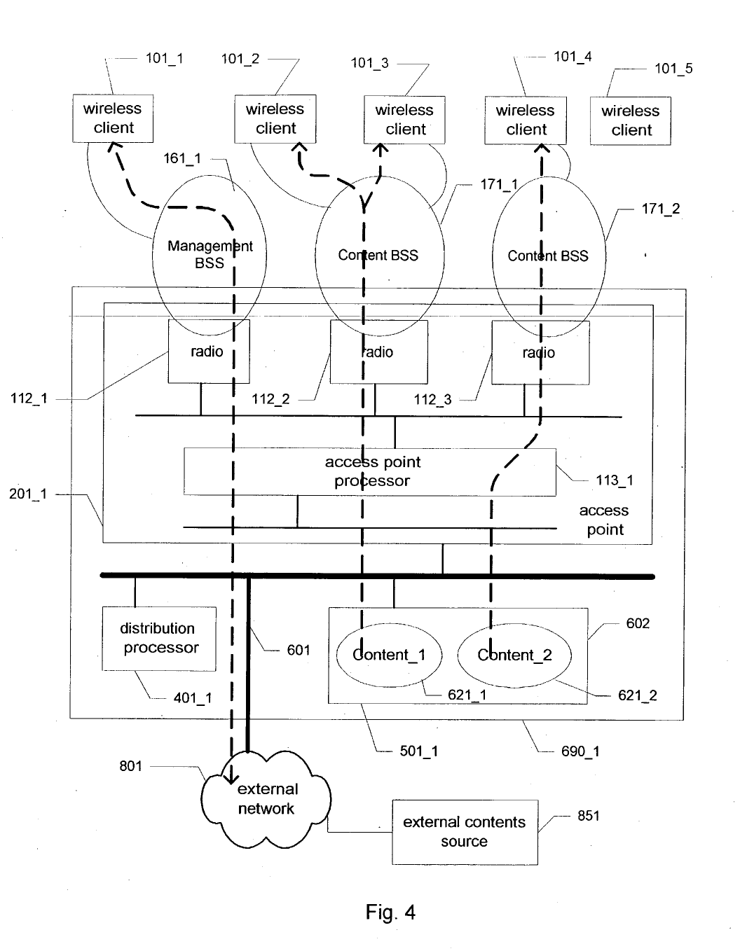

In FIG. 4, the usage of BSS as Content BSS in an exemplary embodiment of the present invention is described. Wireless client 101_2 initially registers with Management BSS 161_1 according to the registration procedure adopted in a given embodiment of the present invention. The wireless client 101_2 requests the base system 690_1 to deliver a certain program referred to as content_1 621_1. The base system 690_1 verifies the eligibility of the requesting wireless client for participating in Content BSS. The base system 690_1 establishes BSS 171_1 to deliver the requested content and notifies wireless client 101_2 of Content BSS 171_1. The BSS selected, which is BSS 171_1 in this case, to serve wireless client for content delivery or bandwidth reservation is referred to as Content BSS. The wireless client 101_2 de-registers from Management BSS 161_1 and re-registers with Content BSS 171_1 and receives the content. All communication between wireless client 101_2 and base system 690_1 now takes place over BSS 171_1.

In certain embodiment of the present invention, the re-registration alone automatically implies de-registration from the BSS that wireless client is registered with at the time of re-registration and base system updates its database accordingly.

Wireless client 101_4 initially registers with Management BSS 161_1 according to the registration procedure adopted in a given embodiment of the present invention. The wireless client 101_4 requests the base system 690_1 to deliver Content_2 621_2. The base system 690_1 verifies the eligibility of the requesting wireless client for participating in Content BSS, base system 690_1 establishes a BSS 171_2 to deliver the requested content and notifies wireless client 101_2 of Content BSS 171_2. The wireless client 101_4 de-registers from Management BSS 161_1 and re-registers with Content BSS 171_2 and receives the content.

Wireless client 101_3 initially registers with Management BSS 161_1 according to the registration procedure adopted in a given embodiment of the present invention. The wireless client 101_3 requests the base system 690_1 to deliver Content_1 621_1. The base system 690_1 verifies the eligibility of the requesting wireless client for participating in Content BSS. The base system 690_1 is aware that Content_1 621_1 is already being delivered over Content BSS 171_1 and notifies the requesting wireless client of Content BSS 171_1. The wireless client 101_3 re-registers with Content BSS 171and receives the content.

The wireless client 101_1 is registered with Management BSS 161_1. The base system 690_1 delivers data between wireless client 101_1 and external network.

When a wireless client requests delivery of content that resides in external contents source 851 reachable over external network 801, distribution processor 401_1 selects a BSS and informs the requesting wireless clients of the selected BSS in the same way as in the case of content delivery of Content_1 and Content_2. The external contents source 851 may be a fee-based subscription service and distribution processor 401_1 may handle information exchange with the subscription service provider for such things as fee payment and encryption key exchange on behalf of the requesting wireless client.

A given embodiment of the present invention may adopt a proper procedure for Content BSS re-registration. Encryption key distribution may be implemented as part of the procedure.

A wireless client may request bandwidth reservation with a specified Quality of Service to base system for its use with external network or another wireless client. This request from an authorized wireless client causes base system to allocate a Content BSS just as in the case of content delivery request.

The base system 690_1 may receive initial registration request over Content BSS 171 from wireless client 101_5. In this case base system 690_1 may grant the registration request if it determines that the registration will not affect the service being provided to the wireless clients registered with Content BSS 171. In case base system 690_1 denies the initial registration request over Content BSS 171, base system 690_1 informs the requesting wireless client 101_5 of Management BSS 161_1 so that wireless client 101_5 may try registration with Management 161_1.

In some embodiment of the present invention it is expected that placement of base system and wireless clients are such that all BSSs established by base system are reachable by all wireless clients. When this expectation is not met, the re-registration process may employ a scheme to verify that the requesting wireless client can be served on the selected BSS so that base system can assign a new BSS to serve the requesting wireless client if needed.

A given embodiment of the present invention implements a procedure to follow in case any of the registration and re-registration procedure fails.

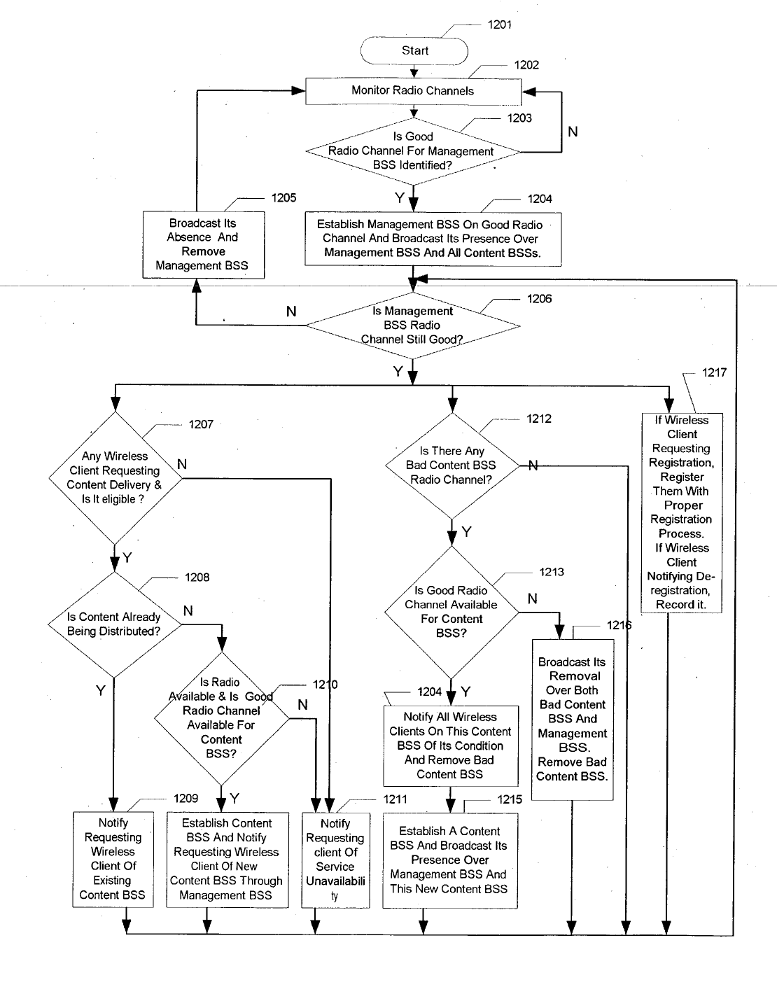

In FIG. 5, the description of how base system manages Management BSS is provided in flowchart in accordance with an exemplary embodiment of the present invention. The base system monitors radio channels and selects a good radio channel and establishes Management BSS with a radio it selects and broadcasts the presence of Management BSS over all existing BSSs that may exist. Each embodiment of the present invention may apply its own criteria as to what a good radio channel is. The base system constantly monitors the status of Management BSS. If the condition of Management BSS deteriorates, base system notifies its intention to remove Management BSS over Management BSS and over any existing Content BSS, after which it removes Management BSS. This process continues. The distribution processor allows wireless clients to register with Management BSS according to a procedure adopted in a given embodiment of the present invention. The base system may disallow any new registration of wireless clients if the new registration is likely to disturb on-going traffic in Management BSS. When base system rejects registration request from a wireless client, it may inform requesting wireless client of an alternative BSS to try registration. When base system directs wireless client to available BSSs, the registration can take shorter time than the case in which wireless client tries different BSSs until wireless client obtains registration. The wireless clients registered with Management BSS issues over Management BSS content delivery request. The base system rejects content delivery requests from wireless client without proper authorization. For the content that is already being delivered, base system notifies requesting client of the existing Content BSS. The base system may select a new BSS for the content delivery, in which case base system establishes a new Content BSS and notifies the requesting wireless client of the new Content BSS. The base system may choose to select an existing Content BSS to deliver content if the data capacity of the existing Content BSS is sufficient to accommodate the new content. If no proper radio channel is available, the content delivery request is denied. Where applicable, base system handles security key distribution between contents source and recipient of the content. The base system may use Management BSS as Content BSS if it determines that the dual use will not keep it from providing service at the required level of Quality of Service. In some embodiment of the present invention base system provides a facility for wireless clients to combine the process of initial registration and content request. In some embodiment of the present invention base system provides a facility for wireless clients to combine the process of de-registration from current BSS and registration with a new BSS. In some embodiment of the present invention, as base system plans to establish/remove BSS, it broadcasts the plan with time indication of future events over all BSSs. In this embodiment wireless clients are aware of all existing BSS and planned establishment/removal of BSSs and wireless clients may use this information in reducing radio channel interferences caused by each other. In another embodiment of the present invention, base system may dynamically establish additional Management BSSs as they are needed and remove each Management BSS as it is no longer needed. In this case if base system decides that existing Management BSSs cannot accommodate any new wireless client, it establishes a new Management BSS to provide services to new wireless clients. As registration request arrives, base system accepts the registration request if it can accommodate the requesting wireless client in the Management BSS over which the request is received. In another embodiment of the present invention, base system may keep multiple Management BSSs whether they are needed currently or not.

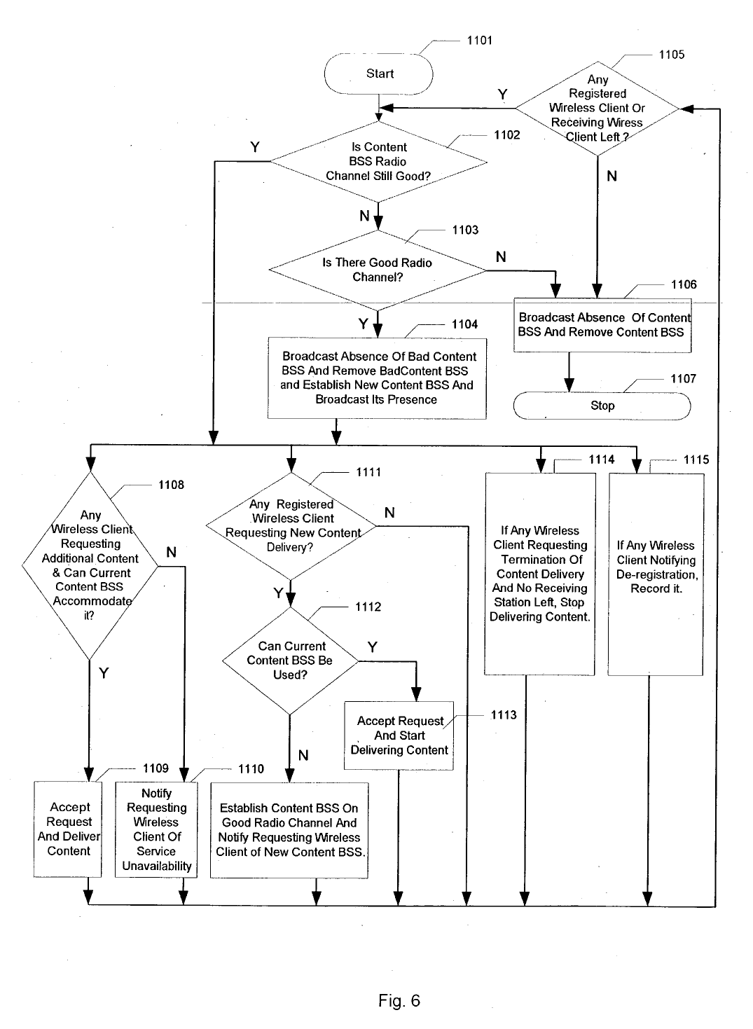

In FIG. 6, the description of how base system manages Content BSSs is provided in flowchart in accordance with an exemplary embodiment of the present invention. The base system constantly monitors the status of each Content BSS. This monitoring process involves examining the reporting of reception quality from wireless clients registered on Content BSS. If base system determines that the radio channel for a given Content BSS is no longer good, it establishes a new Content BSS and delivers contents over the new Content BSS and notifies all wireless clients on bad Content BSS of its removal and the establishment of the new Content BSS. With advance notification of Content BSS removal/establishment, wireless clients should be able to schedule for Content BSS switchover accordingly. In one embodiment, as base system plans to establish/remove BSS, it broadcasts the plan with time indication of events over all BSS. In this embodiment wireless clients are aware of all existing BSSs and planned establishment/removal of BSSs and wireless clients may use this information in reducing radio channel interferences caused by each other. In case there is no good radio channel available to replace the bad Content BSS, the base system may try to deliver as many contents as possible. A wireless client may request termination of content delivery. The base system removes Content BSS for the content if there is no wireless client remaining registered with the BSS. Wireless client registered in Content BSS may request the delivery of a new content. If the requested content is already being delivered, the requesting wireless client is notified of the existing Content BSS. If the requested content is not currently being delivered, base system establishes a new Content BSS. As base system receives request for termination of content delivery over a Content BSS, base system terminates the delivery of the content if there is no other wireless client receiving the content. Base system removes the existing Content BSS if there is no wireless client registered with it. Where applicable, base system handles security key distribution between content source and content consumer.

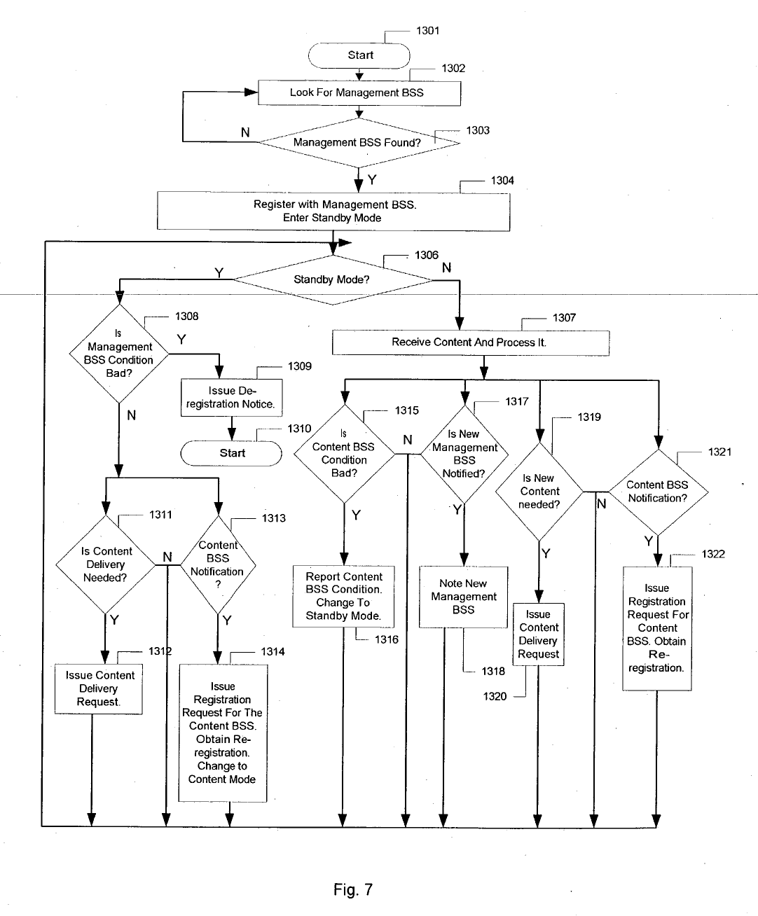

In FIG. 7, activities of wireless client are described in flowchart in accordance with an exemplary embodiment of the present invention. The wireless client scans radio channels and identifies Management BSS and registers with Management BSS when it needs service from base system. If the registration request is denied by base system, wireless client continues by scanning other radio channels for a BSS to register with. The wireless client monitors the condition of Management BSS. If the wireless client determines that Management BSS is bad, the wireless client reports its observation over Management BSS to base system and de-registers with the Management BSS and start looking for a different Management BSS. When wireless client wants to receive content, it issues the request for content delivery over Management BSS. When wireless client wants to reserve bandwidth with Quality of Service requirement, it issues the request for bandwidth reservation with a specified Quality of Service requirement. When Content BSS is notified, the requesting wireless client de-registers with Management BSS and re-registers with Content BSS. The requesting wireless client receives content over Content BSS. If it is a bandwidth reservation request, the wireless client exchanges content with external network over Content BSS.

If the bandwidth requirement changes or wireless client wants to receive new content, the wireless client issues the request over the current Content BSS. It may de-register from the current Content BSS and register with Management BSS to issue a new request. When notified of the new Content BSS, the requesting wireless client de-registers from current Content BSS and re-registers with new Content BSS. In case new content is delivered over the present Content BSS, requesting wireless client stays registered with the present Content BSS. When wireless client no longer desires the content delivery, it reports its intention not to receive the content and de-registers from Content BSS.

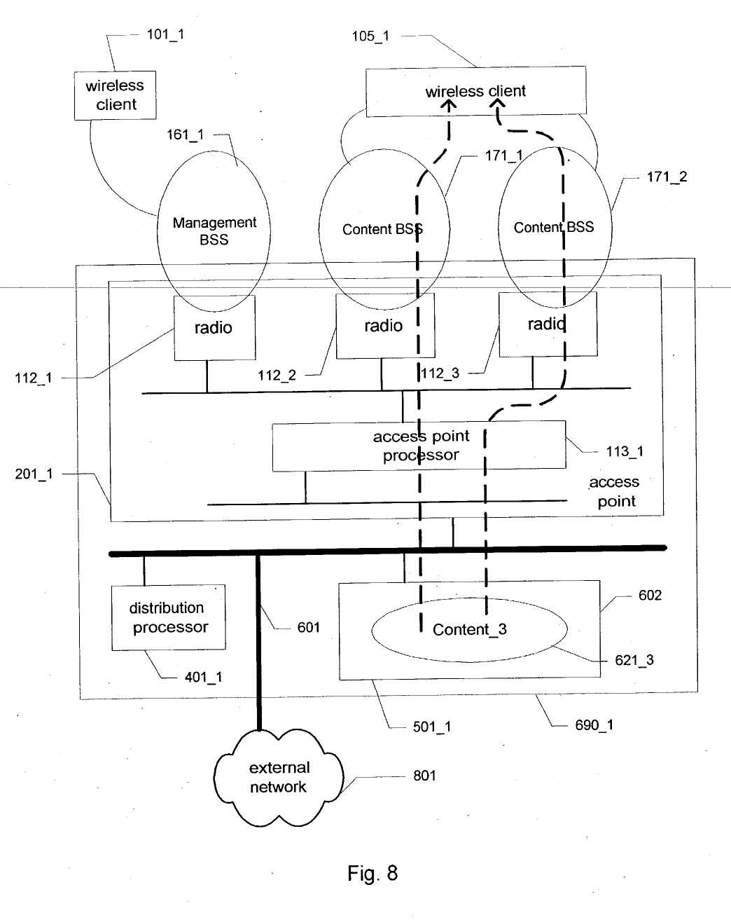

In FIG. 8, description of how two Content BSSs are combined to accommodate a delivery of a single content whose bandwidth requirement exceeds that of a single BSS. Wireless client 105_1 is equipped with two radios. Wireless client 105_1 initially registers with Management BSS 161_1 to request the delivery of content_3 621_3. If the bandwidth required for the delivery exceeds that of a single BSS, base system 690_1 allocates two BSSs for the delivery and informs requesting wireless client of the allocated BSSs.

If a request for bandwidth reservation from a wireless client requires two BSSs and the requesting wireless client is equipped with two radios, base system allocates two BSSs for bandwidth reservation and informs the requesting wireless client of the allocated BSSs.

1. A wireless contents distribution system (WCDS) comprising base system and one or more wireless clients,
wherein base system comprises
one or more access points with each of the access points equipped with one or more radios;
contents source;
external network path;
distribution processor;
backbone link;
wherein access points, contents source, external network path, distribution processor are connected over backbone link, wherein distribution processor coordinates activities within WCDS,
wherein base system establishes one or more Basic Service Sets (BSS),
wherein wireless clients initially register with one of the Basic Service Sets, and each registered wireless client communicates with base system over the Basic Service Set with which the wireless client is registered,
wherein when base system receives request for content delivery or bandwidth reservation from registered wireless clients, base system selects Basic Service Set to serve the request with and informs the requesting wireless client of the selected Basic Service Set so that the requesting wireless client may participate in the selected Basic Service Set through re-registration procedure, wherein the communication between base system and the requesting wireless client takes place over the selected Basic Service Set once the re-registration procedure completes successfully.

2. WCDS of claim 1 wherein base system establishes the maximum number of Basic Service Sets as allowed by the radio resources of the base system and the number of radio channels allowed in a given regulatory domain.

3. WCDS of claim 1 wherein base system maintains traffic load information for each Basic Service Set and dynamically determines the number of Basic Service Sets needed and maintains the determined number of Basic Service Sets.

4. WCDS of claim 3 wherein base system further considers anticipated traffic capacity requirement in determining the number of Basic Service Sets needed.

5. WCDS of claim 3 wherein base system dynamically removes Basic Service Sets when it determines that they are not needed.

6. WCDS of claim 1 wherein base system maintains channel condition information for each Basic Service Set currently in use and each Basic Service Set it plans to use.

7. WCDS of claim 6 wherein when base system determines that radio channel condition of a given Basic Service Set is not good for serving registered wireless clients, base system selects a different Basic Service Set established previously or base system establishes a new Basic Service Set and selects it, and base system informs the registered wireless clients of the selected Basic Service Set and serves the wireless clients on the newly selected Basic Service Set.

8. WCDS of claim 1 wherein in case the content requested for delivery is already being delivered in existing Basic Service Set, base system informs the requesting wireless client of the existing Basic Service Set so that the requesting wireless client may participate in the Basic Service Set through the re-registration procedure.

9. WCDS of claim 1 wherein base system designates one or more Basic Service Sets for the purpose of registration, wherein base system accepts registration request received only over the designated Basic Service Sets.

10. WCDS of claim 9 wherein base system selects one of the Basic Service Sets designated for registration purpose and serves request from wireless client for content delivery or bandwidth reservation with the selected Basic Service Set.

11. WCDS of claim 1 wherein wireless client is equipped with two radios, wherein base system, if wireless client makes request for content delivery or bandwidth reservation that requires two Basic Service Sets, selects two Basic Service Sets for serving the request, wherein base system informs the requesting wireless client of the selected Basic Service Sets and serve the wireless client on the selected Basic Service Sets.
